(19) United States
(12) Patent Application Publication
(10) Pub. No.: US 2007/0267003 A1
(43) Pub. Date: Nov. 22, 2007

(54) System for venting the crankcase of a turbo-charged internal combustion engine

(76) Inventors: Siegfried Sumser, Stuttgart (DE); Wolfram Schmid, Nuertingen (DE)

Correspondence Address: KLAUS J. BACH & ASSOCIATES;PATENTS AND TRADEMARKS, 4407 TWIN OAKS DRIVE, MURRYSVILLE, PA, 15668, US

(21) Appl. No.: 11/801,406

(22) Filed: May 9, 2007

Related U.S. Application Data
(63) Continuation-in-part of application No. PCT/EP05/11423, filed on Oct. 25, 2005.

(30) Foreign Application Priority Data
Nov. 9, 2004 (DE) 10 2004 053 946.4

(51) Int. Cl. F02B 25/06

(52) U.S. Cl. 123/572

(57) ABSTRACT

In a system for venting a crankcase of an internal combustion engine of a motor vehicle provided with an exhaust gas turbocharger, comprising a first vent line which is in communication with the crankcase of the internal combustion engine and opens into an intake duct of the internal combustion engine, and a pump device for withdrawing blow-by gases from the crankcase of the internal combustion engine and increasing the pressure of the blow-by gases in the vent line to the charge air pressure in the intake duct of the internal combustion engine, a second vent line is connected to a bearing housing of the exhaust gas turbocharger and extends to the suction side of the pump device.

This is a Continuation-In-Part Application of International Patent Application PCT/EP2005/011423 filed Oct. 23, 2005 and claiming the priority of German Patent application 2004 053 946.4 filed Nov. 09, 2004.

### BACKGROUND OF THE INVENTION

The invention relates to a system for venting a crankcase of a turbo-charged internal combustion engine of a motor vehicle including a vent line extending from the crankcase to an intake duct downstream of a charge air cooler and including a pump for increasing the pressure of the vent gases supplied to the intake duct.

By means of such venting of the crankcase of an internal combustion engine it is intended to remove from the crankcase combustion gases, usually referred to as blow-by gases, which are produced in the combustion chambers of the internal combustion engine and which enter the crankcase past the piston rings. These blow-by gases contain exhaust gas components such as NOx and SOx as well as combustion air and lubricating oil vapors. In accordance with exhaust gas regulations, such vapors must not be discharged into the open air. For this reason the blow-by gases extracted from the crankcase are returned via a vent line to the intake duct of the internal combustion engine for combustion in the internal combustion engine and for exhaust gas after-treatment.

However, when introducing the blow-by gases into the intake duct of the internal combustion engine, there is a problem that, as a result of oil contamination of the blow-by gases and the high charge air temperatures, deposits and coking are produced on the walls of the compressor of the exhaust gas turbocharger and of the charge air cooler, which may be seriously detrimental to the operability of these components. A possible remedy consists in improved separation of oil from the blow-by gases, which, however, cannot be optimized as desired, for technical reasons.

It is known from the documents DE 36 04 090 A1 and DE 297 09 320 U1, for example, to cause the vent line to open into the intake duct of the internal combustion engine down-stream of the exhaust gas turbocharger and the charge air cooler. That is to say that the blow-by gases are conducted past the exhaust gas turbocharger and the charge air cooler, so that these components cannot be contaminated by the oil components in the blow-by gases.

In this connection further systems for venting a crank-case of an internal combustion engine are known from the prior art, in which, for example, the efficiency of an oil separator provided in the vent line is improved (DE 101 53 120 A1), or the extraction of the blow-by gases from the crankcase is optimized (DE 100 43 796 A1, DE 100 43 801 A1).

It is the object of the present invention to provide a system for venting a crankcase of a pressure-charged internal combustion engine of a motor vehicle in which the venting of the blow-by gases from the crankcase into the intake duct of the internal combustion engine is improved, and, at the same time, a more secure operation of the exhaust gas turbocharger and the charge air cooler is ensured.

### SUMMARY OF THE INVENTION

In a system for venting a crankcase of an internal combustion engine of a motor vehicle provided with an exhaust gas turbocharger, comprising a first vent line which is in communication with the crankcase of the internal combustion engine and opens into an intake duct of the internal combustion engine, and a pump device for withdrawing blow-by gases from the crankcase of the internal combustion engine and increasing the pressure of the blow-by gases in the vent line to the charge air pressure in the intake duct of the internal combustion engine, a second vent line is connected to a bearing housing of the exhaust gas turbocharger and extends to the suction side of the pump device.

Because the blow-by gases are introduced into the intake duct of the internal combustion engine via the vent line downstream of the exhaust gas turbocharger and the charge air cooler, contamination of the exhaust gas turbocharger and charge air cooler by the oil and the exhaust gas components of the blow-by gases is prevented. The use, as the pump device in the vent line, of a particular piston pump which, in combination with a low mass flow rate, can achieve relatively high outlet pressures ensures that the blow-by gases can be introduced into the intake duct, in which increased charge air pressure prevails downstream of the exhaust gas turbocharger.

In a particular embodiment of the invention the pump device is a rotary piston pump, the shaft of which is at the same time the shaft of the exhaust gas turbocharger.

In another embodiment of the invention the pump device is a piston pump which is driven by an output drive of the internal combustion engine and/or by a separate drive, such as an electric motor.

A throttle device with which the mass flow rate through the rotary piston pump can be adjusted is preferably associated with the pump device.

Preferably, there is further provided a second vent line which is in communication at one end with a bearing housing of the exhaust gas turbocharger and at the other with the suction side of the pump device. The second vent line makes it possible, by also venting the bearing housing of the exhaust gas turbocharger, to keep the intake air which flows through the compressor of the exhaust gas turbocharger and through the charge air cooler free of oil and exhaust gas components, which could enter the intake air through the bearing of the exhaust gas turbocharger.

There may further be an air supply line which is in communication at one end with ambient air via a nonreturn valve and at the other with the suction side of the pump device.

In this case a cleaning device may further be arranged in the vent line downstream of the pump device, and the vent line may further be in communication downstream of the cleaning device with an onboard compressed air system of the motor vehicle for supplying compressed air to that system.

The vent line is preferably provided at the crankcase end with an oil filter, in order to limit the amount of oil components in the blow-by gases pumped out of the crankcase.

The invention will become more readily apparent from the following description thereof on the basis of the accompanying drawings:

### BRIEF DESCRIPTION OF THE DRAWINGS

FIG. 1 is a schematic representation of a pressure-charged internal combustion engine with an exhaust gas turbocharger and a venting system according to a first exemplary embodiment of the present invention;

FIG. 2 is a diagram showing the kinematics of the rotary piston pump of the venting system of FIG. 1;

FIG. 3 is a schematic representation of a pressure-charged internal combustion engine with exhaust gas turbocharger and venting system according to a second exemplary embodiment of the present invention, and

FIG. 4 is a schematic representation of a pressure-charged internal combustion engine with exhaust gas turbocharger and venting system according to a third exemplary embodiment of the present invention.

### DESCRIPTION OF THE VARIOUS EMBODIMENTS

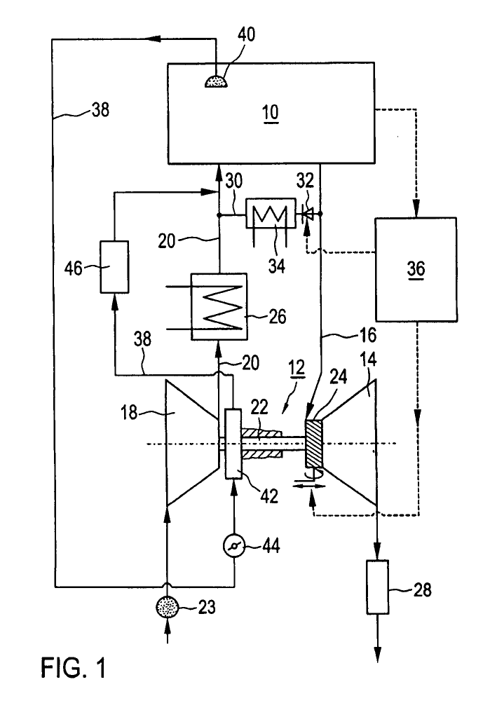

The internal combustion engine 10 represented in FIG. 1, for example a diesel internal combustion engine or a spark ignition engine, is a pressure-charged engine with an exhaust gas turbocharger 12 which includes an exhaust gas turbine 14 in the exhaust gas duct 16 of the internal combustion engine 10 and a compressor 18 in the intake duct 20. The turbine wheel of the exhaust gas turbine 14 and the impeller of the compressor 18 are coupled to one another rotationally via a common shaft 22. The exhaust gas turbine 14 is preferably able to operate in turbo-braking mode in a commercial vehicle application.

In the power drive mode of the internal combustion engine 10, the exhaust gases expelled under pressure from the internal combustion engine 10 into the exhaust duct 16 drive the turbine wheel of the exhaust gas turbine 14, the rotary motion of which is transmitted via the shaft 22 to the impeller of the compressor 18, whereby ambient air is aspirated via an air filter 23 and compressed to an elevated charge air pressure. To improve charging, the exhaust gas turbine 14 is equipped with variable turbine geometry 24.

The combustion air compressed by the compressor 18 is cooled in a charge air cooler 24 arranged downstream of the compressor 18 in the intake duct 20 of the internal combustion engine 10, and then supplied under charge air pressure to the cylinders of the internal combustion engine 10. On the exhaust side the exhaust gases flow out of the internal combustion engine 10 via the exhaust duct 16 into the exhaust gas turbine 14, drive the turbine wheel and then leave the exhaust gas turbine 14 in the expanded state in order to be supplied to an exhaust gas after-treatment device 28 which may contain, for example, a soot filter and a catalytic converter.

Because the exhaust gas turbocharger 12 is already sufficiently known to the person skilled in the art, a detailed description of its construction and operation will be dispensed with.

An exhaust gas recirculation arrangement, which comprises an exhaust gas recirculation line 30 between the exhaust duct 16 upstream of the exhaust gas turbine 14 and the intake duct 20 downstream of the charge air cooler 24, is further associated with the internal combustion engine 10. An adjustable valve 32 and an exhaust gas cooler 34 are arranged in the exhaust gas recirculation line 30.

All the adjustable units of the internal combustion engine 10, such as the valve 32 in the exhaust gas recirculation line 30 and the variable turbine geometry 24 of the exhaust gas turbine 14, are adjusted as a function of the state and operating values of the internal combustion engine 10 by a control unit 36.

In the context of this description the manner in which the mixture is prepared in the intake duct 20 of the internal combustion engine 10 is not discussed in detail, so that an injection system or the like required for such preparation is not represented in the figures.

The crankcase of the internal combustion engine 10 has a venting connection 40 which is optionally provided with an oil filter. A vent line 38 extends therefrom to the intake duct 20 of the internal combustion engine 10 downstream of the exhaust gas turbocharger 12 and of the charge air cooler 26. A pump device 42 for extracting the blow-by gases from the crankcase and for increasing the pressure of the blow-by gases in the vent line 38 to the charge air pressure in the intake duct 20 of the internal combustion engine, and optionally a cleaning device 46, such as an oil separator, are arranged in the vent line 38.

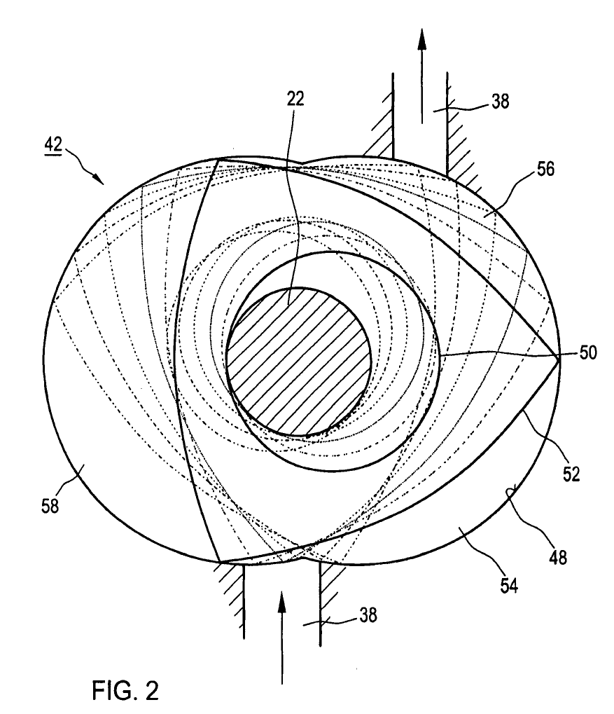

In the present exemplary embodiment, the pump device 42 in the vent line 38 is, as shown in FIG. 1, a rotary piston pump which is arranged on the common shaft 22 of the exhaust gas turbocharger 12. The construction and operation of this rotary piston machine 42 correspond in principle to those of a conventional rotary piston machine, and are illustrated schematically in the diagram of FIG. 2. As is known, three complete two-stroke cycles (induction, compression and discharge) are executed with each revolution of the piston 52 of the rotary piston machine 42.

The rotary piston machine 42 includes, in particular, a housing with side walls and a multi-arc inner cylinder surface 48, a shaft 22 mounted rotatably in the housing and having an eccentric 50, and a triple-arc piston 52 which is mounted rotatably on the eccentric 50 of the shaft 22 and the corners of which move along the inner cylinder surface 48 of the housing in the course of its motion relative to the housing and to the shaft 22, thereby forming induction chambers 54, compression chambers 56 and expansion chambers 58. It should be pointed out again explicitly at this point that the shaft 22 of the exhaust gas turbocharger 12 is utilized for the shaft 22 of this rotary piston machine 42.

Because a rotary piston machine 42 is already sufficiently known to the person skilled in the art, a more detailed explanation of its construction and operation is not necessary.

The rotary piston machine 42 may optionally be a single-rotor, a twin-rotor or even a triple-rotor rotary piston machine. Through the use of the common shaft 22, the rotational speed of the piston 52 of the rotary piston machine 42 is one-third of the rotational speed of the exhaust gas turbocharger 12.

The housing of the rotary piston pump 42 further includes an intake opening and an outlet opening which are each in communication with the vent line 38. The mass flow rate through the rotary piston pump 42 may optionally be adjusted by the degree of opening of a variable throttle device 44 in the vent line 38 upstream of the rotary piston pump 42.

Because very high outlet pressures can be achieved with a rotary piston pump 42 in a simple manner and in combination with compact construction even at relatively low mass flow rates, this rotary piston pump 42 is especially suitable for extracting the blow-by gases from the crankcase of the internal combustion engine 10 and for introducing same into the intake duct 20 directly upstream of the internal combustion engine 10. The quantities of blow-by gases usually amount to only approximately 1% of the mass throughput of air of the internal combustion engine 10; nevertheless, they must be compressed to the elevated charge air pressure in the intake duct 20 in order to be able to be admixed to the combustion air in the intake duct 20.

A second preferred exemplary embodiment of the present invention will now be explained with reference to FIG. 2. The same components are denoted by the same reference numerals as in the first exemplary embodiment and repetition of the description of the structure and operation is avoided.

As in the first exemplary embodiment, the venting connection 40 is connected to a vent line 38 which opens into the intake duct 20 of the internal combustion engine 10 downstream of the exhaust gas turbocharger 12 and the charge air cooler 26. For extracting the blow-by gases from the crankcase of the internal combustion engine 10 and increasing the pressure of the blow-by gases in the vent line 38 to the charge air pressure in the intake duct 20, a pump device 42′ is arranged in the vent line 38.

In the present, second exemplary embodiment the pump device 42′ in the vent line 38 is in the form of a piston pump of small dimensions, the particular geometry of which produces high efficiency and which ensures relatively high outlet pressures despite the low mass flow rates. The piston pump 42′ is advantageously driven via a drive 64 of the internal combustion engine 10, but may alternatively be driven by a separate electric motor.

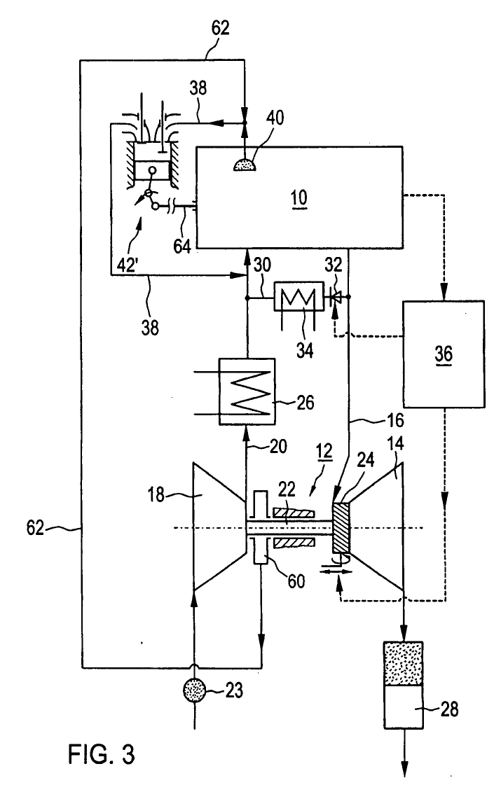

The other components of the internal combustion engine 10 correspond to those of the first embodiment, so that the same advantages and effects can also be achieved with the construction shown in FIG. 3.

To supplement this venting of the blow-by gases from the crankcase of the internal combustion engine 10, a device for venting the exhaust gases from the exhaust gas turbocharger 12, which is constructed as follows, is further provided.

In order to keep the charge air in the intake duct 20 free of oil and oil mist also coming from the exhaust gas turbocharger 12, the bearing housing of the exhaust gas turbocharger 12 is separated from the compressor 18 by means of a buffer volume 60, indicated schematically in FIG. 3, and this buffer volume 60 has a venting connection which is connected with one end to a second vent line 62. The other end of this second vent line 62 is also connected to the suction side of the piston pump 42′ located in the vent line 38 of the crankcase.

By means of this second vent line 62, therefore, exhaust gases which enter the bearing housing of the exhaust gas turbocharger 12 from the exhaust gas turbine can be extracted via of the buffer volume 60, and passage of the oil components contained in the exhaust gases to the compressor 18 of the exhaust gas turbocharger 12, and therefore into the intake air, can be prevented. It should be mentioned in this connection that, because of the generally present coupling to the lubrication circuit of the internal combustion engine 10 or to the crankcase of the internal combustion engine 10, the pressure in the bearing housing of the exhaust gas turbocharger 12 corresponds approximately to the pressure in the crankcase.

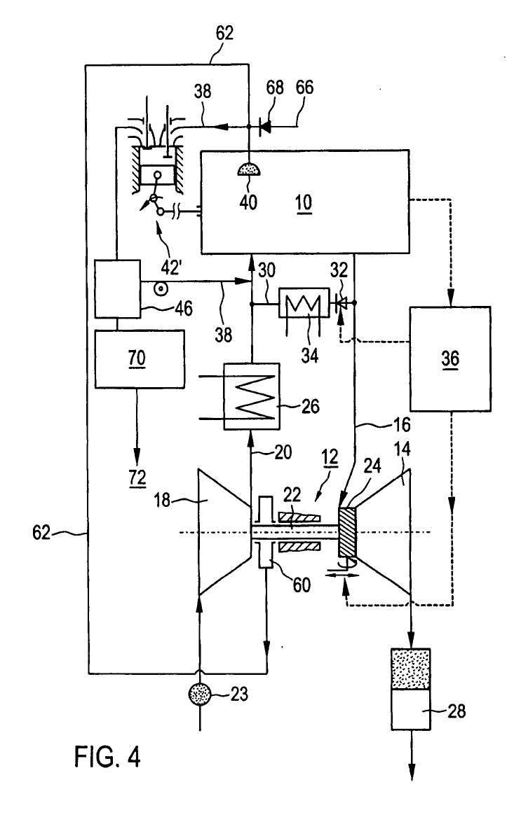

A third exemplary embodiment of the present invention, which represents a modification of the second exemplary embodiment explained above, will now be described in detail with reference to FIG. 4.

The design of the internal combustion engine 10 and of the crankcase venting system corresponds to that of the second exemplary embodiment of FIG. 3. The venting device of the bearing housing of the exhaust gas turbocharger 12 is also provided. In the exemplary embodiment of FIG. 4, however, the piston pump 42′ in the vent line 38 of the crankcase is used at the same time as the air compressor of an onboard compressed air system 72 of the motor vehicle.

For this purpose the suction side of the piston pump 42′ is connected not only to the venting connection 40 of the crankcase and to the second vent line 62 of the bearing housing of the exhaust gas turbocharger 12, but additionally to an air line 66 to ambient air via a nonreturn valve 68. In this way the piston pump 42′ principally takes in conditioned ambient air. A cleaning device 46 (for example, an oil separator) is arranged in the vent line 38 on the pressure side of the piston pump 42′, which cleaning device 46 may optionally also include a carbon device. The contaminants extracted from the total gas flow in the vent line 38 by the cleaning device 46 are supplied via the vent line 38 with a small propellant gas flow to the intake line 20 of the internal combustion engine 10. The air for the onboard compressed air system 72 cleaned in the cleaning device 46 is supplied to a pressure accumulator 70 from which the compressed air can be drawn for the consumers as required.

If the modified system of the piston pump 42′ and the air compressor of the onboard compressed air system 72 is also to be utilized for supporting the cold-start behavior of the internal combustion engine 10 and for after-treatment of the exhaust gas thereof, the propellant flow in the vent line 38 may be controlled or increased, for example, via adjustable valve cross-sections in the environment of the cleaning device 46, in such a way that the air/fuel ratio rises. The increased quantity of combustion air is then also available to the exhaust gas after-treatment device 28 for the chemical processes to be promoted.

Whereas the present invention has been described on the basis of preferred exemplary embodiments with reference to the appended drawings, it is obvious to the person skilled in the art that numerous changes and modifications thereto can be undertaken without departing from the scope of protection of the invention, as defined in the appended claims.

For example, it is also possible to combine the venting device of the bearing housing of the exhaust gas turbocharger 12 (second exemplary embodiment), and/or the additional use of the pump device 42, 42′ for the onboard compressed air system 72 (third exemplary embodiment), with the venting system of the crankcase, represented in FIG. 1, according to the first exemplary embodiment.

What is claimed is:

1. A system for venting a crankcase of a turbo-charged internal combustion engine of a motor vehicle, comprising a crankcase and intake and exhaust ducts (20, 16), said system including a first vent line (38) extending from the crankcase to the intake duct (20) downstream of an exhaust gas turbocharger (12), a charge air cooler (26), a pump device (42, 42′) arranged in the vent line (38) for extracting blow-by gases from the crankcase of the internal combustion engine (10) and increasing the pressure of the blow-by gases in the vent line (38) to a charge air pressure in the intake duct (20) of the internal combustion engine, and a piston and a second vent line (62) extending from a bearing housing of the exhaust gas turbocharger (12) to the suction side of the pump device (42, 42′) for removing exhaust gases passing from the exhaust gas turbine (14) to the bearing.

2. The system as claimed in claim 1, wherein the pump device (42) is a rotary piston pump the shaft of which is at the same time the shaft (22) of the exhaust gas turbocharger (12).

3. The system as claimed in claim 1, wherein the pump device (42′) is a piston pump which is driven by one of an output drive (64) of the internal combustion engine (10) and a separate drive.

4. The system as claimed in claim 2, wherein a throttle device (44) for adjusting the mass flow rate through the rotary piston pump is associated with the pump device (42, 42′).

5. The system as claimed in claim 1, wherein an ambient air supply line (66) is provided in communication at one end via a non-return valve (68) with ambient air and at the other end with the suction side of the pump device (42, 42′).

6. The system as claimed in claim 1, wherein a cleaning device (46) is further arranged in the vent line (38) downstream of the pump device (42, 42′).

7. The system as claimed in claim 6, wherein the vent line (38) is in communication with an onboard compressed air system (72) of the motor vehicle downstream of the cleaning device (46).

8. The system as claimed in claim 1, wherein the vent line (38) is provided with an oil filter (40) disposed at the crankcase end thereof.
